(19) United States
(12) Patent Application Publication
(10) Pub. No.: US 2025/0300970 A1
(43) Pub. Date: Sep. 25, 2025

(54) SYSTEMS AND METHODS FOR RANSOMWARE EVENTS

(71) Applicant: Dymium Inc., Los Gatos, CA (US)

(72) Inventors: Denzil Wessels, Los Gatos, CA (US); Igor Plotnikov, Sunnyvale, CA (US); Valentyn Kamyshenko, Los Gatos, CA (US)

(21) Appl. No.: 19/081,839

(22) Filed: Mar. 17, 2025

Related U.S. Application Data
(60) Provisional application No. 63/567,385, filed on Mar. 19, 2024.

(51) Int. Cl. H04L 9/40

(52) U.S. Cl. CPC H04L 63/0428; H04L 63/0281; H04L 63/0884; H04L 63/105; H04L 63/1416

(57) ABSTRACT

A method and system manages access to private data across networked environments using a data access proxy and artificial intelligence resources. A user request to access a data item from a private database or file-sharing service is received and analyzed by a named-entity recognition model to identify sensitive information. The user's identity and activity history are validated to detect suspicious behavior. The data item is retrieved, transformed by a large language model applying privacy and security rules, such as generating synthetic data or redacting personally identifiable information, and delivered securely to the user. Direct access to the underlying database or service is prevented, ensuring data security. The process integrates proxy-mediated retrieval with AI-driven analysis and transformation to safeguard sensitive information.

### CROSS-REFERENCE TO RELATED APPLICATION(S)

This application claims the benefit and priority of U.S. Provisional Patent Application Ser. No. 63/567,385, filed on Mar. 19, 2024, which is hereby incorporated by reference herein, including all references and appendices cited therein, for all purposes, as if fully set forth herein.

### FIELD

The various exemplary embodiments herein generally relate to data security, ease of use, and integration. More particularly, the various exemplary embodiments herein relate to systems and methods of providing data security via a database proxy engine positioned within a network flow between a database source and a user or a computer system accessing the database source. Additionally, the various exemplary embodiments herein solve the challenges of cost and time associated with a data migration, the time and effort to utilize data from disparate sources, and balances data protection with data access.

### BACKGROUND

Providing security to network devices or a data center is an important concern as data security attacks are becoming increasingly prevalent. Multiple security features may be implemented at different network layers to protect networks, data, and services from malicious attacks. The traditional approach to data protection is founded on the concept of perimeter protection with firewalls as controlled access points. One type of such firewall is a traditional Open Systems Interconnection (OSI) layer 3-4 solution that checks for Internet Protocol (IP) addresses and ports and blocks undesired traffic based on this information. Such a solution is strictly based on transport protocol, unaware of the payload. A more modern take on this approach is a protocol-aware OSI layer with multiple firewalls that adds the art of Intrusion Protection System (IPS). The system inspects the traffic, finds dangerous patterns, and provides or blocks access. However, this approach is becoming less and less productive due to protocols becoming end-to-end encrypted, such as from the clients to the applications.

Another common approach is another type of firewall, known as a Web Application Firewall, which inspects the HTTP request and responses from and to a web application. The firewall looks for threats like SQL injection and data leakage. However, the traffic or requests that the firewall can inspect are very indirect and can be difficult to interpret and act upon. Therefore, threats of accessing data via malicious users are still present.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a data security system for safeguarding private data across databases and file-sharing platforms. The data security system also includes at least one data access proxy communicatively coupled to at least one private database and at least one file-sharing service. The system also includes at least one server communicatively coupled to the at least one data access proxy, the at least one server configured to: identify a user and a request from the user to access at least one data item stored within the at least one private database or shared via the at least one file-sharing service; validate the user and the request by inspecting the user's identity, evaluating the user's activity history, and determining permissions and restrictions associated with the user and the at least one data item; retrieve the at least one data item from the at least one private database or the at least one file-sharing service; inspect one or more security attributes of the at least one data item, including data origin and intended confidentiality level; and transform the at least one data item based on one or more privacy rules, where the transformation includes at least one of redacting sensitive information, substituting information with proxy data, or adding encryption to the at least one data item, and where the transformed data item is provided to the user without granting direct access to the at least one private database or the at least one file-sharing service. Other embodiments of this aspect include corresponding computer systems, apparatus, and computer programs recorded on one or more computer storage devices, each configured to perform the actions of the methods.

Implementations may include one or more of the following features. The data security system where the at least one file-sharing service includes at least one of a network file system (NFS), a server message block (SMB) system, Google Drive, or Dropbox. The at least one server is further configured to normalize the request into a standard dialect of structured query language (SQL) before retrieving the at least one data item. The one or more security attributes further include data sharing permissions, and where the at least one server is configured to enforce the data sharing permissions based on a role of the user. The transformation of the at least one data item further includes adding synthetic data configured to track the user's activities with the transformed data item. The at least one server is further configured to establish a secure tunnel over an encrypted authenticated connection between the at least one data access proxy and the user. The at least one server is further configured to combine data from a plurality of private databases into a virtual database, and where the transformed data item is derived from the virtual database. Implementations of the described techniques may include hardware, a method or process, or computer software on a computer-accessible medium.

One general aspect includes a data security system for protecting private data against ransomware attacks across databases and file-sharing platforms. The data security system also includes at least one security proxy communicatively coupled to at least one private database and at least one file-sharing service, where the at least one file-sharing service includes at least one of NFS, SMB, Google Drive, or Dropbox. The system also includes at least one server communicatively coupled to the at least one security proxy, the at least one server configured to: receive a request from a user to access or share at least one data item stored in the at least one private database or transmitted via the at least one file-sharing service; validate the request by evaluating the user's identity, activity history, and permissions associated with the at least one data item; monitor the at least one data item in real-time to detect unauthorized changes indicative of a ransomware attack, including sudden alterations in data format or encryption status; transform the at least one data item based on security policies, where the transformation includes at least one of redacting sensitive information, providing synthetic data, or implementing write protection to prevent unauthorized encryption; and transmit the transformed data item to the user while maintaining secure storage and exchange of the at least one data item within the at least one private database or the at least one file-sharing service. Other embodiments of this aspect include corresponding computer systems, apparatus, and computer programs recorded on one or more computer storage devices, each configured to perform the actions of the methods.

Implementations may include one or more of the following features. The data security system where the at least one server is further configured to block a file overwrite action by the user when the unauthorized changes are detected in the at least one data item. The at least one server uses artificial intelligence and machine learning (AI/ML) methodologies to detect the sudden alterations in data format or encryption status indicative of the ransomware attack. The transformation of the at least one data item further includes obfuscating sensitive information within the at least one data item based on the security policies. The at least one server is configured to manage encryption keys for the at least one data item when the at least one data item is stored in an encrypted form in the at least one private database. The at least one server is further configured to provide encryption-at-rest services for the at least one data item stored in the at least one file-sharing service. The at least one server is further configured to implement a kill switch mechanism to disable the at least one security proxy in response to a detected breach, where the kill switch mechanism allows an authorized administrator to override the disablement. Implementations of the described techniques may include hardware, a method or process, or computer software on a computer-accessible medium.

One general aspect includes a data security system for managing access to private data across networked environments. The data security system also includes at least one data access proxy communicatively coupled to at least one private database and at least one file-sharing service. The system also includes an artificial intelligence resource may include at least one named-entity recognition model and at least one large language model, the artificial intelligence resource communicatively coupled to at least one server. The system also includes the at least one server configured to operate the at least one data access proxy and the artificial intelligence resource to: receive a request from a user to access at least one data item stored in the at least one private database or shared via the at least one file-sharing service; analyze the request using the at least one named-entity recognition model to identify sensitive information within the request; validate the user by inspecting the user's identity and activity history using the artificial intelligence resource to detect suspicious behavior; retrieve the at least one data item from the at least one private database or the at least one file-sharing service; transform the at least one data item using the at least one large language model based on predefined privacy and security rules, where the transformation includes generating synthetic data or redacting personally identifiable information; and provide the transformed data item to the user through a secure connection, where the user is prevented from directly accessing the at least one private database or the at least one file-sharing service. Other embodiments of this aspect include corresponding computer systems, apparatus, and computer programs recorded on one or more computer storage devices, each configured to perform the actions of the methods.

Implementations may include one or more of the following features. The data security system where the at least one named-entity recognition model is trained to detect personally identifiable information (PII) including names, titles, and organizations within the request. The at least one large language model is trained on a corpus of organizational legacy resources including files, emails, and documents to generate the synthetic data. The suspicious behavior detected by the artificial intelligence resource includes a sudden increase in frequency of requests for the at least one data item from the user. The at least one server is further configured to generate a risk score for the user based on the user's activity history and the suspicious behavior detected by the artificial intelligence resource. The secure connection is established using transport layer security (TLS) encryption between the at least one data access proxy and the user. Implementations of the described techniques may include hardware, a method or process, or computer software on a computer-accessible medium.

### BRIEF DESCRIPTION OF THE DRAWINGS

The accompanying drawings, where like reference numerals refer to steps of the process and embodiments, together with the detailed description below, are incorporated in and form part of the specification and serve to illustrate further embodiments of concepts that include the claimed disclosure and explain various principles and advantages of those embodiments.

The process and composition disclosed herein have been represented where appropriate by conventional symbols in the flowcharts, photographs, or drawings, showing only those specific details that are pertinent to understanding the embodiments of the present disclosure so as not to obscure the disclosure with details that will be readily apparent to those of ordinary skill in the art having the benefit of the description herein.

FIG. 1 illustrates an embodiment of the network architecture deploying the Semantic Data Proxy between users and private data sources for secure access.

FIG. 2 illustrates an embodiment of the functional flow of data requests and responses processed through the Semantic Data Proxy with security enforcement.

FIG. 3 illustrates an embodiment of the Virtual DB Engine's operation within the Data Access Proxy for managing normalized SQL queries and access control.

FIG. 4 illustrates an embodiment of the Semantic Data Proxy accessing and aggregating data from multiple organizations' databases securely.

FIG. 5 illustrates an embodiment of a traditional direct connection model between data consumers and data silos, exposing security risks.

FIG. 6 illustrates an embodiment of the Semantic Data Proxy enabling secure access to disparate data sources without requiring data migration.

FIG. 7 illustrates an embodiment of the data security system architecture using Ghost Data Services for ransomware protection in file-sharing environments.

FIG. 8 illustrates an embodiment of a flowchart detailing a method for managing access to private data using a data access proxy and AI resources.

FIG. 9 illustrates an embodiment of a flowchart outlining a method for validating user requests and transforming data based on security policies.

FIG. 10 illustrates an embodiment of a flowchart depicting a method for protecting private data against ransomware using real-time monitoring and recovery.

### DETAILED DESCRIPTION

The disclosed systems and methods provide a framework for securing private data across networked environments through the use of a data access proxy, also referred to as a Semantic Data Proxy (SDP), ghost database, or proxy database. This proxy-based approach, positioned between users or applications and private data sources such as databases and/or file-sharing services, ensures controlled and protected access while preventing direct user interaction with the underlying data repositories. The SDP acts as a secure intermediary, inspecting user requests and responses to enforce privacy policies, mitigate unauthorized access, and protect sensitive information, including personally identifiable information (PII), across diverse deployment scenarios, including private clouds, public databases, or organizational data networks.

One functionality of the SDP involves receiving user requests via native protocols and validating them through an integrated artificial intelligence (AI) resource. This AI resource, comprising named-entity recognition (NER) models, large language models (LLMs), and neural networks, analyzes requests to detect sensitive data, validates users by inspecting identities and activity histories for suspicious behavior (e.g., unusual query patterns or frequency spikes), and assesses permissions and restrictions based on role-based access controls. For non-sensitive data, the SDP may deliver the data in its original format (e.g., plain text); for sensitive data, it applies transformations such as redaction, substitution with proxy or synthetic data, or encryption, ensuring data is presented on a need-to-know basis while adhering to regulations like HIPAA or GDPR. These transformations, driven by privacy rules and organizational policies, leverage LLMs trained on legacy resources (e.g., files, emails, documents) to generate anonymized or altered responses, often including tracking mechanisms to monitor user activity and prevent data breaches.

The system prohibits direct database access, routing all interactions through the SDP, which serves as a protective firewall or zero-trust barrier. This architecture supports advanced security features, including automatic PII detection via pattern searching or neural networks, data organization by attributes (e.g., confidentiality, sensitivity), and the creation of virtual databases via APIs (Application Programming Interface) to combine data from multiple sources for unified access. For instance, in a merger scenario, a single query can efficiently aggregate loyalty program data across organizations, saving time and reducing risks compared to direct database queries. The SDP also implements behavioral analysis to identify anomalies, generates risk scores, and can block or alert on suspicious activities, enhancing protection against threats like malware or unauthorized data access.

Further features include real-time monitoring and transformation capabilities, where the SDP normalizes requests (e.g., into standard SQL), enforces data sharing permissions dynamically, and maintains audit trails for compliance. Machine learning techniques enable the system to detect and neutralize emerging cyber threats, such as generative AI-based malware, while supporting multiple programming languages and protocols for interoperability. In case of a compromised AI resource, a kill switch mechanism allows administrators to disable or remediate the resource, minimizing damage.

This proxy-based data security solution, enhanced by AI and machine learning, offers a scalable, flexible approach to safeguard sensitive data, optimize resource usage, and ensure regulatory compliance, making it ideal for enterprises managing complex data environments securely and efficiently.

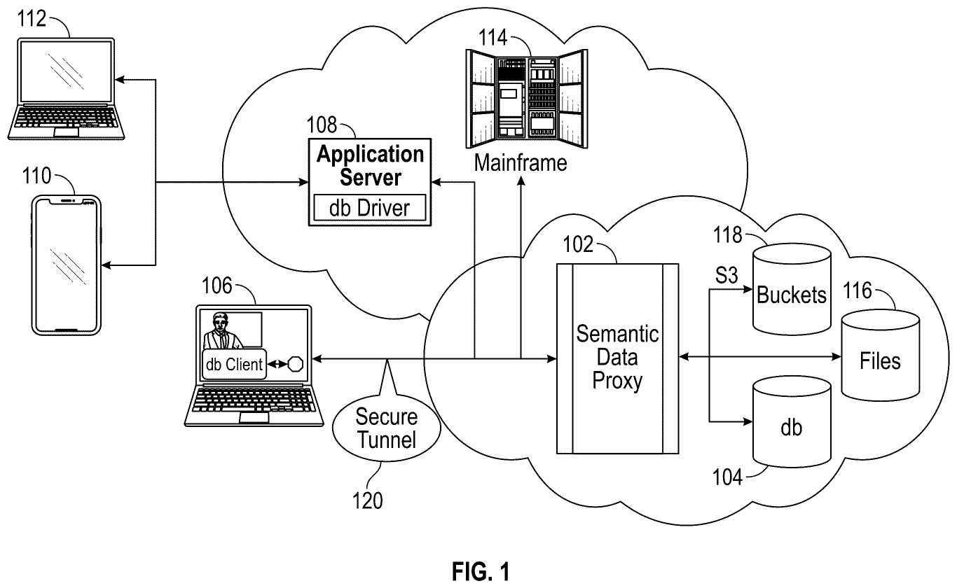

FIG. 1 illustrates an embodiment of the deployment of the disclosed data security technology with multiple data consumers, where a Semantic Data Proxy (SDP) 102, also referred to as a data access proxy, proxy database, or ghost database, is positioned within the network flow between a database 104 and a user 106. The SDP 102 operates as a secure intermediary, accessing unencrypted data present within various data sources, such as an application server 108, a server 110, a computer device 112, a mainframe 114, as well as files 116, S3 buckets 118, or other collections of information, including data warehouses, data lakes, private clouds, cloud storage, data storage engines, servers with multiple databases, networks of databases, destination databases, or any source of collective information to which a user may request access, such as binary, numeric, voice, video, text, photograph, or script data, or source or object code.

The SDP 102 shields and mimics a private database 104, incorporating components of a real database, such as private data, ensuring users access the SDP 102 as if they are interacting directly with the private database 104, prohibiting users' direct access to the private database 104 and routing all access through the SDP 102 using a zero-trust security model that requires verification from everyone attempting to gain access to resources on the network. The user 106, who may be a client, a customer, an employee of an organization, a data scientist, a web server, a data consumer, or any individual or entity accessing the database, interacts with the SDP 102 from a computer connected to an internet service, which can be any type of wired and/or wireless public or private network, including cellular networks, local area networks, wide area networks such as the Internet or World Wide Web, personal area networks, or sub-networks with various communication networking devices, including processors implemented in hardware and/or firmware executed by special purpose computers, logic circuits, or hardware circuits. The SDP 102 establishes a secure tunnel 120 over an encrypted authenticated connection, such as using Transport Layer Security (TLS), to connect the local application to a local host socket, enhancing security by preventing direct network connectivity and reducing risks of data breaches, while ensuring no direct user access and maintaining data integrity through one or more modules configured to protect data designated as private.

The SDP 102 examines every data request received from any user, reviews responses before releasing the data item, adjusts the request or response based on privacy policies or protocols associated with the request or user, and performs authentication using existing mechanisms, streamlining integration without requiring multiple logins, ensuring controlled access and acting as a protective wall or firewall between the user 106 and the private database 104.

This setup incorporates an artificial intelligence resource, comprising at least one named-entity recognition model, at least one large language model, and at least one neural network application, connected to one or more servers to identify, validate, and analyze user requests for suspicious activity, such as sudden changes in query scope or frequency, while automatically detecting sensitive information and personally identifiable information (PII) through pattern searching or neural networks to separate sensitive from non-sensitive data, adhering to policies like HIPAA or GDPR, reducing response times and policy configuration efforts.

If the data sought is not sensitive, it may be prepared and presented in plain text or its original format without modification or redaction; if sensitive, the SDP 102 alters the data, potentially concealing PII, replacing it with proxy or synthetic data, or adding encryption, using machine learning techniques to recognize anomalous or outlier user activity, generate risk scores, and enforce permissions and restrictions based on role-based access controls, ensuring data is presented on a need-to-know basis consistent with applicable data regulations for a particular geographic region.

The SDP 102 supports multiple network interfaces implementing various data access protocols, such as SQL, NoSQL, REST, and GraphQL, including native protocols like PostgreSQL, Oracle DB, or MySQL, to handle data from diverse sources, such as files 116, S3 buckets 118, data warehouses, or data lakes, and may create virtual databases by supplying multiple Application Programming Interfaces (APIs) to combine data from disparate sources, organizing data by attributes like confidentiality, sensitivity, type, nature, field, or quantity, while maintaining audit trails and countering ransomware threats through intelligent data redaction, write protection, and behavioral analysis, ensuring robust data security across digital ecosystems.

The SDP 102 is configured to determine a user identity through authentication mechanisms that verify the requesting entity's credentials, digital signatures, access tokens, or other identifiers. This determination process involves matching presented credentials against stored authorized user profiles, enabling precise identification of the requesting user before processing any data access requests. The user identity determination is an initial security step that forms the foundation for subsequent validation of access privileges and application of appropriate data transformation rules.

In various embodiments, the system may implement a browser widget interface that resembles a large language model application, providing an intuitive query entry point for users. This interface may include an enterprise policy control component that enforces organizational data access rules while maintaining a familiar user experience. The widget connects to the SDP infrastructure, ensuring all queries are properly validated, transformed, and secured according to established policies, while presenting a streamlined interaction model that reduces training requirements and improves adoption rates across the organization.

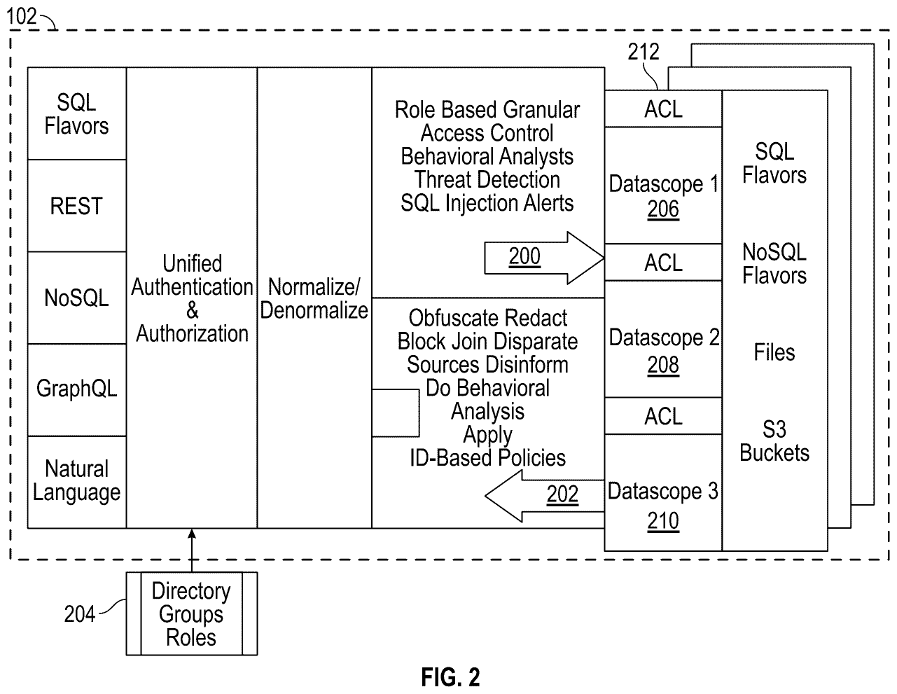

FIG. 2 presents a functional diagram of the disclosed data security technology, detailing the operational architecture of a Semantic Data Proxy (SDP) 102 within a networked environment. In this diagram, the data request flow proceeds from left to right, designated as element 200, while the response flow proceeds in the opposite direction, designated as element 202, illustrating the bidirectional communication path managed by the SDP 102 to ensure secure data handling. The SDP 102, implemented as a software component executing on a server infrastructure with multi-core processors (e.g., Intel Xeon™ or AMD EPYC™), sufficient random access memory (RAM) (e.g., 64 gigabytes or greater), and solid-state drive (SSD) storage, provides a protocol layer facilitating client connections. This layer supports authentication of users requesting data or information through a process that involves identifying user-specific attributes, such as role, identity, or other credentials, retrieved from a user directory 204, which is a structured database (e.g., PostgreSQL™, MySQL™, or LDAP™) stored on the same or a separate server, containing data access policies, user databases, and related metadata necessary to inspect and verify user identity and associated data access privileges.

The SDP 102 normalizes incoming requests, such as converting them into a standardized dialect of Structured Query Language (SQL) using a middleware layer written in a programming language like Python™ or Java™, leveraging libraries such as SQLAlchemy™ or Java Database Connectivity™ (JDBC) for protocol translation. This normalization supports multiple network interfaces implementing data access protocols, including SQL (e.g., ANSI SQL™ PostgreSQL™), NoSQL™ (e.g., MongoDB™, Cassandra™), REST (using Hypertext Transfer Protocol Secure (HTTPS) with JavaScript Object Notation (JSON) payloads), and GraphQL (via GraphQL servers like Apollo™), as well as native protocols such as PostgreSQL™, Oracle Database™ (DB), or MySQL™, such as Datascope 1 206, Datascope 2 208, and Datascope 3 210. These interfaces are configured on the SDP 102 using network sockets and application programming interface (API) endpoints, secured with Transport Layer Security (TLS) protocols implemented via libraries like OpenSSL, to handle data from heterogeneous sources across wired and/or wireless networks, including cellular networks, local area networks, wide area networks (e.g., the Internet), or personal area networks, interconnected via sub-networks with communication devices such as routers, switches, and firewalls.

The SDP 102 enforces role-based granular access control, accessing a control list (e.g., Access Control List 212, ACL) stored in the user directory 204 or an external identity and access management (IAM) system, to inspect each user request based on directory information. This control utilizes machine learning algorithms, implemented using frameworks like TensorFlow or PyTorch, running on the SDP 102′s server to perform behavioral analysis on user history and behavior, identifying benign or malicious patterns. For example, the SDP 102 flags suspicious behavior-such as sudden increases in query frequency, outliers in data volume or type sought, or requests exceeding permission scopes-using neural network models trained on historical query data to detect anomalies, generating risk scores via probabilistic reasoning. If a user's request exceeds permissions, the SDP 102 blocks access, preventing retrieval of any information and triggering monitoring or alerts, ensuring no direct user access to private databases and maintaining a zero-trust security model requiring verification for all access attempts.

The system may leverage multiple AI resources simultaneously, comparing and analyzing responses from different artificial intelligence models to enhance accuracy and security. This approach enables the identification and remediation of potential errors through weighted voting logic that removes outlying responses. The system may maintain a dynamically updated preferred list of AI resources based on performance metrics including response quality, security compliance, and processing latency. Load balancing techniques distribute requests across these resources based on predefined criteria such as data sensitivity, query complexity, or computational demands, ensuring optimal performance while maintaining security standards.

In scenarios where potential security breaches are detected, the system implements a kill switch mechanism that provides rapid isolation and containment capabilities. This kill switch mechanism enables administrators to immediately disable specific SDP instances, connection paths, or entire security proxy networks to prevent potential data exfiltration or unauthorized access propagation. The mechanism functions as an emergency circuit breaker, allowing authorized administrators to completely sever connections between users and protected data sources when anomalous behaviors are detected. Importantly, the kill switch implementation includes override capabilities restricted to authorized administrators with appropriate authentication credentials, ensuring that legitimate business operations can be restored after security evaluations are completed and threats are mitigated. The kill switch operation is logged in tamper-proof audit trails to maintain accountability and provide forensic information about activation circumstances.

The data security system generates normalized risk scores that reflect the security profile of each request and requesting entity. These scores incorporate multiple factors including historical user behavior patterns, query characteristics, requested data sensitivity, and compliance requirements. The system maintains dashboards with metrics regarding potential data leakage risks, quantifying the security performance of various AI resources and the quality of requests submitted by particular individuals or departments. This risk quantification framework enables proactive security management by identifying high-risk patterns before they result in data breaches, while providing administrators with clear visibility into system-wide security status.

To further enhance data protection, the SDP transforms sensitive data items by obfuscating specific elements, such as personally identifiable information (PII) or proprietary details, based on predefined security policies. This obfuscation process modifies the data's presentation—e.g., altering identifiable patterns or replacing critical values with contextually ambiguous placeholders-while preserving its utility for authorized users. Implemented through AI-driven algorithms, this transformation ensures that sensitive information remains unintelligible to unauthorized parties, aligning with organizational security policies and regulatory requirements like GDPR or HIPAA.

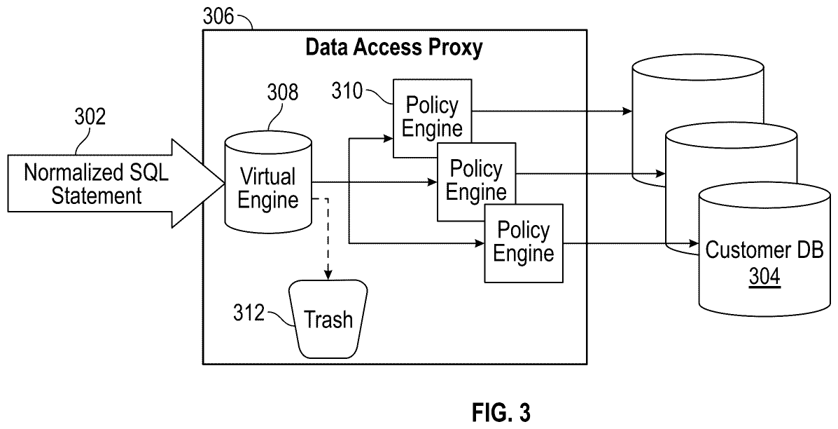

FIG. 3 illustrates a ghost database operation, detailing the operational process where a normalized SQL statement 302 is processed to ensure secure and controlled access. The Data Access Proxy 306 contains a Virtual DB Engine 308 that receives and processes the normalized SQL statement 302. This Virtual DB Engine 308 functions as an abstraction layer that unifies disparate data sources into a single logical view, enabling seamless querying across heterogeneous systems without requiring data migration or consolidation. The normalized SQL statement 302, a standardized Structured Query Language (SQL) query converted using middleware layers written in Python or Java with libraries like SQLAlchemy™ or Java™ Database Connectivity (JDBC), is evaluated according to an access policy, defined within policy engines 310 integrated into the Data Access Proxy 306, to manage interactions with the Customer DB 304, ensuring limited data is provided as schemas and tables, which are then routed back through the Virtual DB Engine 308 for processing.

The SDP facilitates transformations between structured and unstructured data formats, enabling seamless data access regardless of source format. For example, the system can convert data from document-oriented formats like MongoDB to relational structures in SQL databases, or vice versa, without requiring users to understand the underlying data storage mechanisms. This capability significantly enhances data accessibility and utility while maintaining security controls across format transitions. The system applies appropriate security transformations based on data sensitivity regardless of format, ensuring consistent protection as information moves between structured and unstructured representations.

The Customer DB 304, implemented as an SQL database on a server with multi-core processors (e.g., Intel™ Xeon or AMD™ EPYC), sufficient random access memory (RAM) (e.g., 64 gigabytes or greater), and solid-state drive (SSD) storage, stores tightly defined subsets of data from multiple sources, accessible via native protocols like PostgreSQL™, Oracle™ Database (DB), or MySQL™, secured with Transport Layer Security (TLS) protocols via libraries like OpenSSL. The Data Access Proxy 306, executing on the same or a separate server, acts as a secure intermediary, prohibiting direct user access to private databases and maintaining a zero-trust security model requiring verification for all access attempts.

When data items are stored in an encrypted form within the private database, the SDP server manages the associated encryption keys to ensure secure access and integrity. This key management process involves generating, storing, and rotating encryption keys using a secure key vault integrated into the server infrastructure, with access restricted to authenticated processes. By handling key lifecycle operations, the server enables seamless decryption for authorized requests while preventing unauthorized access, supporting compliance with data protection standards and enhancing ransomware resistance

Connected to the Virtual DB Engine 308 within the Data Access Proxy 306 is a Trash system 312, which safely handles deleted or quarantined data items, temporarily storing potentially malicious or suspicious content for further analysis before permanent deletion, preventing accidental data loss while maintaining security integrity. The policy engines 310, implemented using machine learning frameworks like TensorFlow™ or PyTorch™, enforce role-based granular access control and behavioral analysis to detect anomalies, ensuring compliance with policies like HIPAA or GDPR.

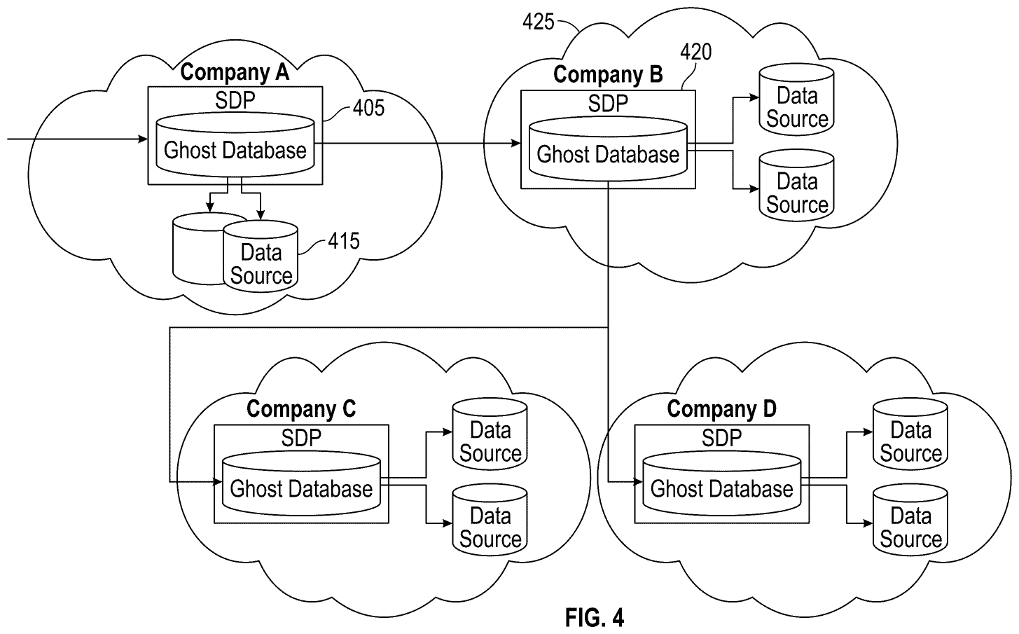

FIG. 4 illustrates an example embodiment of the disclosed data security technology, where the system accesses a plurality of databases simultaneously, retrieves information from multiple databases, combines the data, processes the data, and prepares a response, leveraging Semantic Data Proxies (SDPs) to ensure secure and controlled access without direct user interaction. In this diagram, a user request is routed to SDP 405 of Company A 410, part of a plurality of organizations participating in a study, such as analyzing shoe sales within a particular region, requiring data from multiple shoe-selling companies. The SDP 405, implemented as a software component on a server infrastructure with multi-core processors, sufficient random access memory (RAM) (e.g., 64 gigabytes or greater), and solid-state drive (SSD) storage, inspects the request and request attributes, using an artificial intelligence resource with named-entity recognition models, large language models, and neural networks to evaluate user identity, activity history, and permissions, ensuring no direct access to private databases. The SDP 405 contains a ghost database that accesses limited data from one or more Company A Data Sources 415, which may include private databases, data warehouses, data lakes, files, S3 buckets, or other data sources, retrieving information in the form of tables or schemas via native protocols.

After inspection, SDP 405 of Company A 410 contacts SDP 420 of Company B 425, another entity within the plurality of organizations, which performs similar inspection and retrieves data from Company B Data Sources 430, ensuring controlled access through role-based granular access control and behavioral analysis to detect suspicious activity, such as sudden query increases or outliers, using machine learning algorithms implemented with frameworks like TensorFlow or PyTorch. The SDP 420, also implemented on a similar server infrastructure, combines and processes data from the Company B Data Sources 430, maintaining security by altering sensitive data-such as concealing personally identifiable information (PII), replacing it with proxy or synthetic data, or adding encryption-while adhering to policies like HIPAA or GDPR. Following retrieval of a complete set of data, the SDP 405 combines the data from both the Company A Data Sources 415 and Company B Data Sources 430, prepares the data, and presents the results, such as combined sales data of shoes sold in a particular region, via a secure connection using network protocols like HTTP/HTTPS and TLS, ensuring no direct user access and maintaining a zero-trust security model requiring verification for all access attempts.

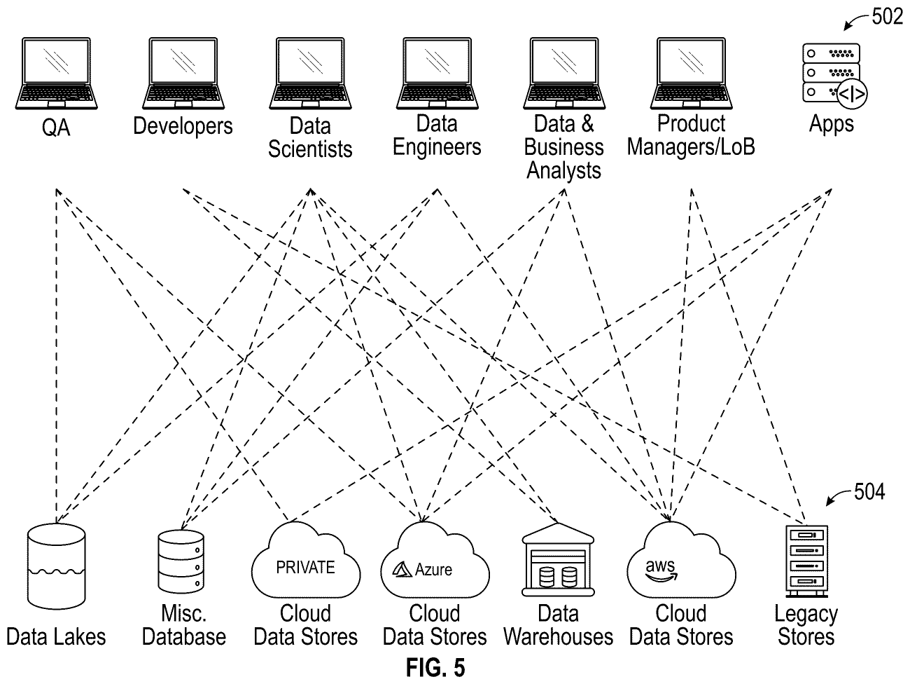

FIG. 5 illustrates the establishment of direct connections for legacy data access, depicting a network architecture where multiple consumers 502 connect directly to various data silos 504, highlighting the challenges and risks associated with this traditional approach. The consumers, representing a diverse group of end-users and applications, include apps, product managers/line of business (LoB), data and business analysts, data engineers, data scientists, developers, and quality assurance (QA) personnel, each requiring access to data for operational, analytical, or developmental purposes. These consumers 502 are implemented on computing devices, such as laptops, desktops, or servers with multi-core processors, sufficient random access memory (RAM) (e.g., 16-64 gigabytes), and solid-state drive (SSD) or hard disk drive (HDD) storage, operating on operating systems like Linux, Windows, or macOS, and connecting via wired and/or wireless networks, including cellular, local area, wide area (e.g., Internet), or personal area networks, using communication devices like routers, switches, and firewalls.

The data silos 504, representing the storage and management infrastructure for data, encompass legacy stores, AWS™ cloud data stores, data warehouses, Azure™ cloud data stores, private cloud data stores, miscellaneous databases, and data lakes, each storing private data such as databases 104, files 116, S3 buckets 118, (see FIG. 1) data warehouses, data lakes, private clouds, cloud storage, or other collective information like binary, numeric, voice, video, text, photograph, or script data, or source or object code. These data silos 504 are implemented on server infrastructures with multi-core processors, sufficient RAM, and SSD storage, hosted on platforms, or on-premises data centers, using database management systems and cloud storage services, secured with Transport Layer Security (TLS) protocols via libraries, and accessible via various protocols. The direct network connectivity between consumers 502 and data silos 504, established using network protocols like HTTP/HTTPS and TCP/IP, requires extensive resources in terms of time, money, and effort for data migration, involving unneeded data duplication, weeks of manual data pulling to build new datasets, denial of critical resource access, and reliance on antiquated techniques like printing and redacting at high cost, increasing vulnerability to breaches, unauthorized database access, and daily theft of database dumps.

To be sure, this architecture poses significant security and operational challenges, as direct connections expose data to risks such as unauthorized access, data breaches, and ransomware threats, making it difficult for organizations to secure data within the data silos 504, determine access permissions, and manage mega volumes of data across different versions and global data centers. The system struggles to ensure only authorized personnel, such as users, access appropriate information while preventing personally identifiable information (PII) leakage, and risks operational delays if access is denied or data copies are created, doubling storage costs and heightening vulnerability to breaches.

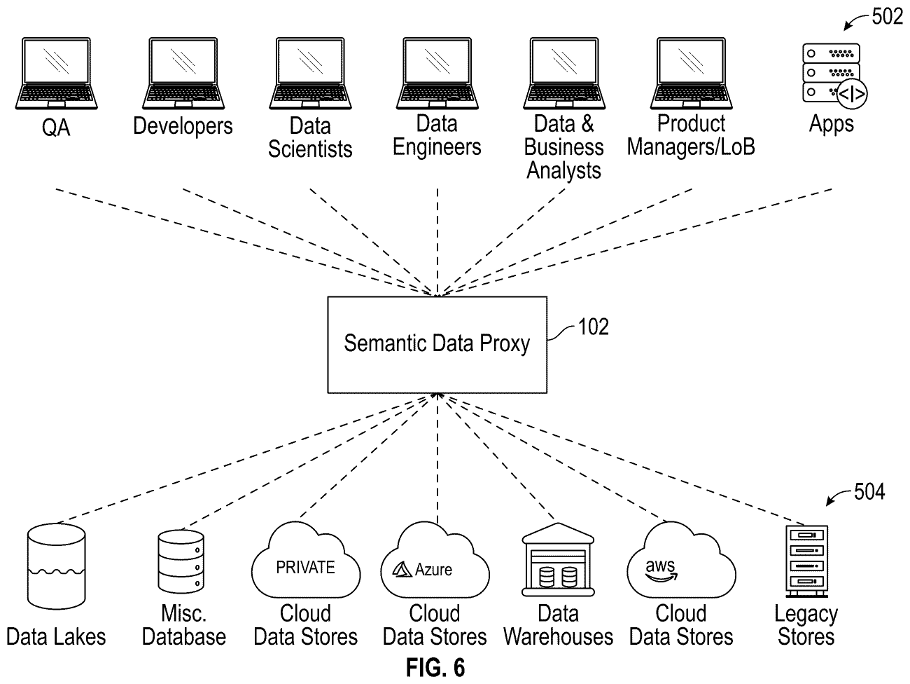

FIG. 6 illustrates an exemplary embodiment of the disclosed data security technology, addressing the challenges of cost and time associated with data migration while balancing data protection with access, requiring no changes to infrastructure. In this diagram, multiple consumers 502 connect to various data silos 504 through a central Semantic Data Proxy (SDP) 102, leveraging virtual databases or ghost databases to provide a secure, unified interface without direct data connections, as contrasted with FIG. 5. The consumers 502, including applications, product managers/line of business (LoB), data and business analysts, data engineers, data scientists, developers, and quality assurance (QA) personnel, are implemented on computing devices such as laptops, desktops, or servers.

The SDP 102, acting as a single security front end, determines who is querying what, collects behavior for analysis, and develops security policies. The SDP 102 enables zero trust for data use, protecting personally identifiable information (PII) and creating a complete audit trail, enforcing role-based granular access control and behavioral analysis using an artificial intelligence resource with named-entity recognition models, large language models, and neural networks to detect suspicious activity, such as sudden query increases or outliers, generating risk scores via machine learning algorithms implemented with frameworks like TensorFlow or PyTorch, and altering sensitive data by concealing PII, replacing it with proxy or synthetic data, or adding encryption, adhering to policies like HIPAA or GDPR. This setup supports real-time data access for scenarios like a mega merger of hotel chains with different database forms, cloud storage vendors, and query methods, consolidating information into a central, secure place without data copies, leveraging virtual databases via application programming interfaces (APIs) to combine data from disparate sources, organizing data by attributes like confidentiality, sensitivity, type, nature, field, or quantity, and countering ransomware threats through intelligent data redaction, write protection, and behavioral analysis, maintaining no direct user access to private databases and ensuring compliance with regulatory requirements.

### EXTENSION FOR FILE SHARES AND RANSOMWARE

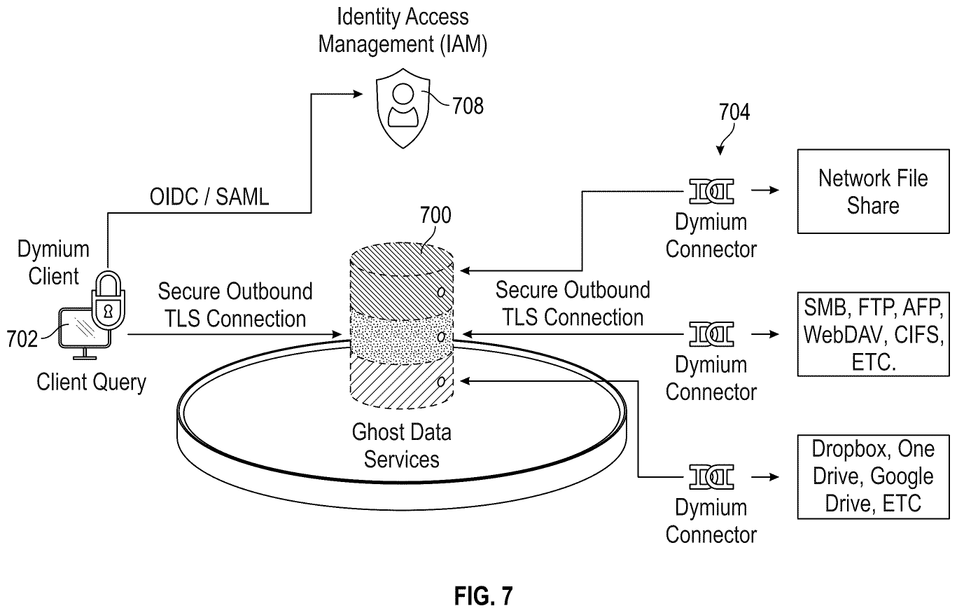

FIG. 7 illustrates an embodiment of an advanced data security system across digital ecosystems, detailing the architecture for a secure data management system that includes Ghost Data Services 700, a central repository acting as a secure intermediary. In this diagram, clients interact with the Ghost Data Services 700 through a Dymium Client 702, an interface or application for submitting data queries, designed for remote end-user access, implemented on computing devices. Communication between the Dymium Client 702 and the Ghost Data Services 700 (equivalent to the SDP 102 of FIG. 1) is secured via an outbound Transport Layer Security (TLS) connection, encrypting data using protocols implemented via libraries like OpenSSL to protect against eavesdropping and tampering, though TLS or Secure Sockets Layer (SSL) is not required in some embodiments, and can occur over wired and/or wireless networks, including cellular, local area, wide area (e.g., Internet), or personal area networks, using communication devices like routers, switches, and firewalls.

On the edge, multiple Dymium Connectors 704 serve as interfaces or gateways for data exchange with external systems or services, such as file servers supporting Network File Share 706 (e.g., SMB, FTP, NFS), WebDAV, CIFS, or other protocols, and cloud-based file-sharing services like Dropbox™, One Drive™, Google Drive™, etc., facilitating shared access to files and directories across a network. These Dymium Connectors 704 utilize secure TLS connections for outbound data transfers, maintaining data integrity and security as it moves in and out of the Ghost Data Services 700, implemented on server infrastructures with multi-core processors, sufficient RAM, and SSD storage, hosted on platforms like AWS, Azure, or on-premises data centers, using network protocols like HTTP/HTTPS and TCP/IP, secured with TLS via OpenSSL. The Ghost Data Services 700, executing on similar server hardware, analyzes data integrity and security during transit, identifying and preventing reintegration of compromised data, whether encrypted or obfuscated, back to its origin, offering proactive defense against ransomware attacks targeting collaborative environments, and recognizing sudden format changes like unauthorized encryption attempts.

Overseeing access control is an Identity Access Management (IAM) system 708, which authenticates and authorizes user and machine interactions with the system, using standards such as OpenID Connect (OIDC) or Security Assertion Markup Language (SAML) to manage digital identities, ensuring only authorized users or machines can access or manipulate data, identifying and blocking malicious users or entities through role-based granular access control and behavioral analysis using machine learning algorithms implemented with frameworks like TensorFlow or PyTorch. The IAM system 708, implemented on servers with multi-core processors, sufficient RAM, and SSD storage, enforces a zero-trust security model requiring verification for all access attempts, maintaining audit trails and countering ransomware threats through intelligent data redaction, write protection, and behavioral analysis, adhering to policies.

For data items stored in file-sharing services or third-party platforms, the SDP server provides encryption-at-rest services to safeguard data when not in transit. This feature encrypts files at the storage level using AES-256 or similar standards, managed by the server in coordination with the Dymium Connectors 704, ensuring that data remains protected against unauthorized access or ransomware even when residing on external platforms. Authorized users access decrypted versions through the SDP, while the underlying encrypted state persists in the file-sharing environment, enhancing security across distributed ecosystems.

### EXAMPLE METHODS OF IMPLEMENTATION

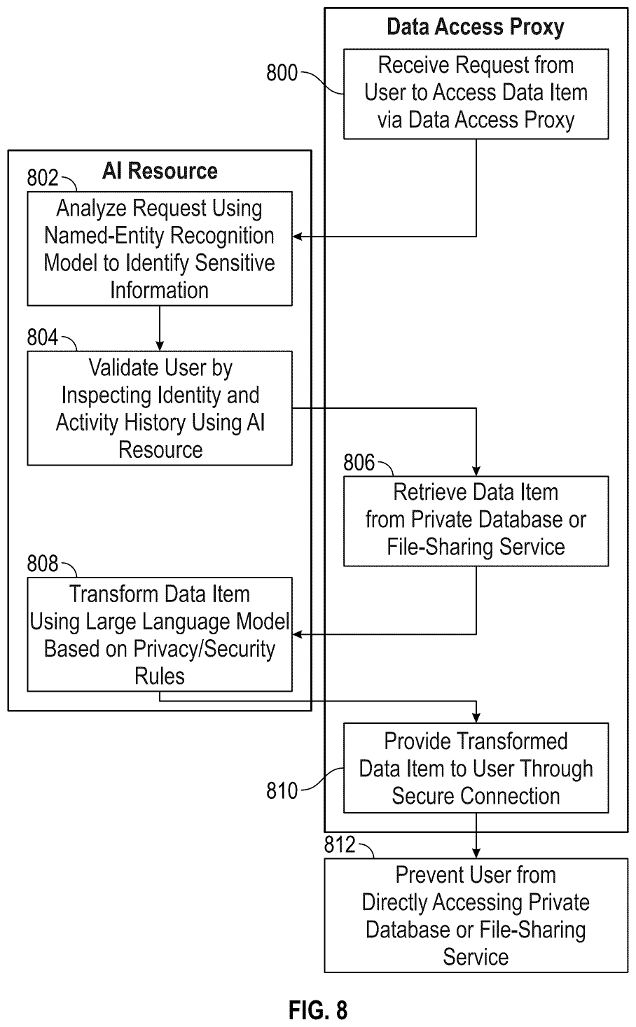

Referring now to FIG. 8, the present disclosure describes a method for managing access to private data across networked environments using a data security system comprising at least one data access proxy, an artificial intelligence (AI) resource, and at least one server, as illustrated in the flowchart. In step 800, the data access proxy receives a request from a user to access at least one data item stored in a private database or shared via a file-sharing service, such as Network File System (NFS), Server Message Block (SMB), or cloud-based services like Google Drive or Dropbox. The proxy intercepts this request, formatted as a query (e.g., SQL query, API call), over a network connection, preventing direct user access to the underlying data sources and ensuring secure routing through the system.

In step 802, the AI resource's named-entity recognition (NER) model analyzes the user request to identify sensitive information, such as personally identifiable information (PII) including names, titles, and organizations, within the request text. Utilizing natural language processing (NLP) techniques and trained on datasets of sensitive terms, the NER model flags any PII to ensure security validation, enhancing protection against data exposure at the request stage. This step is for maintaining privacy before further processing occurs.

Moving to step 804, the AI resource validates the user by inspecting the user's identity (e.g., credentials, authentication tokens) and activity history (e.g., past queries, access patterns) to detect suspicious behavior, such as a sudden increase in request frequency or unusual data access patterns. The server, using machine learning algorithms, compares this information against predefined security thresholds, potentially generating a risk score to assess the user's legitimacy, ensuring robust access control before data retrieval.

In step 806, the data access proxy retrieves the requested data item from the private database or file-sharing service, querying the data source using standardized protocols (e.g., SQL, REST API) and transferring the data securely to the proxy. This step ensures no direct user access to the source, maintaining the system's zero-trust architecture by routing all interactions through the proxy, which acts as a secure intermediary.

Proceeding to step 808, the AI resource's large language model (LLM) transforms the retrieved data item based on predefined privacy and security rules. The transformation may involve generating synthetic data, such as anonymized or fictional data mimicking the original structure, or redacting PII, such as replacing names with placeholders. Trained on organizational legacy resources (e.g., files, emails, documents), the LLM applies natural language generation techniques to ensure the transformed data retains utility while protecting sensitive information, balancing security with usability.

In step 810, the data access proxy delivers the transformed data item to the user through a secure connection established using Transport Layer Security (TLS) encryption between the proxy and the user's device. This ensures data confidentiality and integrity during transmission, preventing unauthorized interception and maintaining compliance with security standards, while the proxy continues to block direct access to the data sources.

Finally, in step 812, the system prevents the user from directly accessing the private database or file-sharing service, enforcing a zero-trust architecture where all interactions are mediated by the data access proxy. By maintaining control over request routing and response delivery, the proxy ensures that users cannot bypass security measures, safeguarding sensitive data and reinforcing the method's effectiveness in managing access across networked environments.

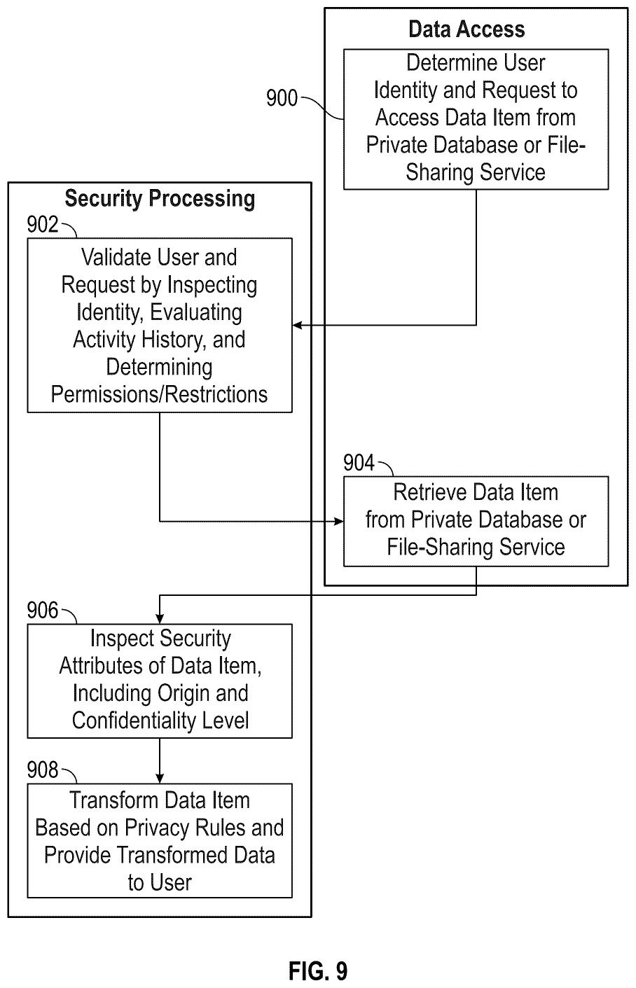

Referring now to FIG. 9, the present disclosure describes a method for managing access to private data across networked environments using a data security system comprising at least one data access proxy and a security processing component, as illustrated in the flowchart. In step 900, the system determines a user identity and a request from the user to access at least one data item stored within a private database or shared via a file-sharing service, such as Network File System (NFS), Server Message Block (SMB), or cloud-based platforms like Google Drive or Dropbox. This initial step involves intercepting the user's query, formatted as an API call or database query, through the data access proxy to establish the user's credentials and the nature of the requested data, ensuring secure handling from the outset.

In step 902, the security processing component validates both the user and the request by inspecting the user's identity, evaluating the user's activity history, and determining the permissions and restrictions associated with the user and the data item. This validation process uses machine learning algorithms to analyze historical access patterns, such as request frequency or unusual behavior, and compares them against predefined security policies. It also assesses role-based permissions (e.g., access levels for different user types) and restrictions (e.g., data sensitivity limits), ensuring only authorized access is granted before proceeding.

Moving to step 904, the data access proxy retrieves the requested data item from the private database or file-sharing service, using standardized protocols (e.g., SQL, REST API) to query and securely transfer the data. This step ensures no direct user access to the source, maintaining a zero-trust architecture where all interactions are mediated through the proxy, enhancing data protection by routing data through a controlled intermediary.

In step 906, the security processing component inspects one or more security attributes of the data item, including its origin (e.g., database source, file-sharing platform) and intended confidentiality level (e.g., public, restricted, confidential). This inspection involves analyzing metadata and applying security rules to assess the data's sensitivity, ensuring appropriate handling based on its attributes before any transformation occurs, thereby safeguarding sensitive information.

Finally, in step 908, the security processing component transforms the data item based on privacy rules and provides the transformed data to the user. The transformation may include redacting sensitive information (e.g., masking personally identifiable information), substituting information with proxy data (e.g., anonymized placeholders), or adding encryption to the data item to enhance security. The transformed data is delivered to the user via a secure connection, ensuring no direct access to the private database or file-sharing service is granted, thus maintaining robust data privacy and security across the networked environment.

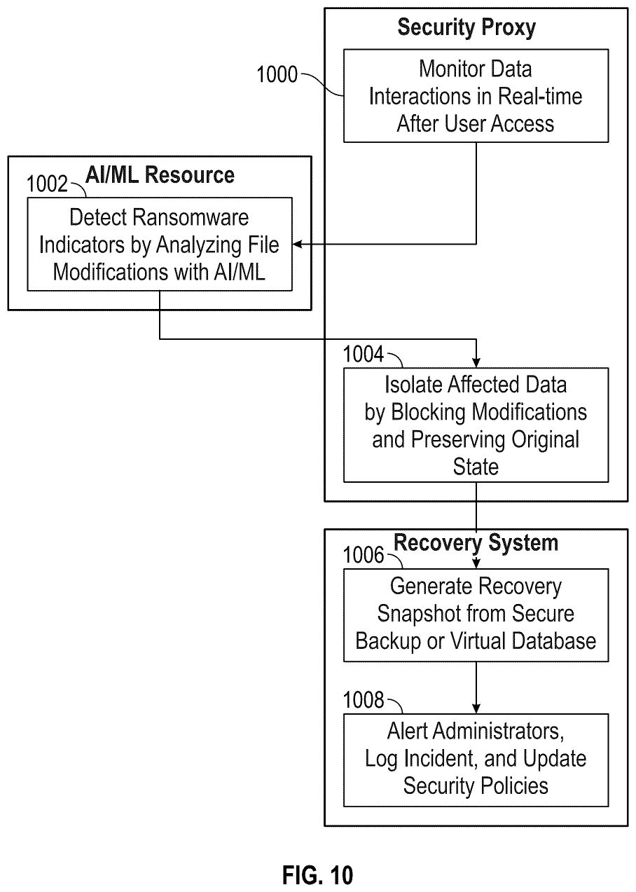

Referring now to FIG. 10, the present disclosure describes a method for protecting private data against ransomware attacks across networked environments, utilizing a data security system comprising at least one security proxy, an AI/ML resource, and a recovery system, as illustrated in the flowchart. In step 1000, the security proxy monitors data interactions in real-time after a user accesses a data item from a private database or file-sharing service, such as Network File System (NFS), Server Message Block (SMB), or cloud-based platforms like Google Drive or Dropbox. This continuous monitoring, conducted through the proxy, tracks file modifications and user activities to detect potential threats, ensuring proactive defense against unauthorized changes post-access.

In step 1002, the AI/ML resource detects ransomware indicators by analyzing file modifications with artificial intelligence and machine learning (AI/ML) methodologies. This analysis identifies anomalies such as sudden encryption attempts, format changes, or unauthorized data alterations, leveraging trained models (e.g., neural networks) on historical data patterns to recognize ransomware signatures, thereby enabling rapid threat identification within the system.

The system's ransomware protection capabilities include implementing write protection mechanisms that prevent unauthorized modification of data items. This write protection operates at multiple levels, including applying read-only attributes to sensitive files, implementing versioning controls that require administrative approval for modifications, enforcing change management workflows that validate file alterations against security policies, and deploying file system filters that block specific encryption operations associated with known ransomware signatures. The write protection implementation may be dynamically adjusted based on threat intelligence, user behavior patterns, and the sensitivity classification of the protected data items, ensuring appropriate protection without unnecessarily hindering legitimate work processes.

Moving to step 1004, the security proxy isolates affected data by blocking further modifications and preserving the original data state. This isolation prevents additional damage by restricting write access to the compromised files, maintaining a secure copy of the original data for forensic analysis or recovery, ensuring the integrity of the data environment is safeguarded against ongoing ransomware activity.

In step 1006, the recovery system generates a recovery snapshot of the data item from a secure backup or virtual database, restoring the data's integrity to its pre-attack state. This step involves accessing encrypted or redundant storage systems (e.g., cloud backups, virtual databases combining multiple data sources) and applying restoration protocols to reinstate the original data, mitigating the impact of the ransomware attack and ensuring operational continuity.

Finally, in step 1008, the recovery system alerts administrators, logs the incident, and updates security policies to mitigate future threats. This response includes sending notifications via secure channels (e.g., email, SMS) to authorized personnel, recording detailed event data (e.g., timestamps, affected files) in an audit log, and modifying security rules (e.g., enhancing AI/ML models, adjusting access controls) to prevent recurrence, thereby strengthening the system's resilience against ransomware.

Where appropriate, the functions described herein can be performed in one or more of hardware, software, firmware, digital components, or analog components. For example, the encoding and/or decoding systems can be embodied as one or more application-specific integrated circuits (ASICs) or microcontrollers that can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the embodiments of the disclosure as described herein.

In some embodiments, a computer system may be implemented as a cloud-based computing environment, such as a virtual machine operating within a computing cloud. In other embodiments, the computer system may itself include a cloud-based computing environment, where the functionalities of the computer system are executed in a distributed fashion. Thus, a computer system, when configured as a computing cloud, may include pluralities of computing devices in various forms.

In general, a cloud-based computing environment combines the computational power of a large grouping of processors (such as within web servers) and/or the storage capacity of a large grouping of computer memories or storage devices. Systems that provide cloud-based resources may be utilized exclusively by their owners or be accessible to outside users who deploy applications within the computing infrastructure to obtain the benefit of large computational or storage resources. The cloud is formed by a network of web servers that comprise a plurality of computing devices, such as the computer system, with each server providing processor and/or storage resources. These servers manage workloads provided by multiple users (e.g., cloud resource customers or other users). Typically, each user places workload demands upon the cloud that vary in real-time, sometimes dramatically, depending on the type of business associated with the user.

The corresponding structures, materials, acts, and equivalents of all means or step-plus-function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, enabling others of ordinary skill in the art to understand the present technology for various embodiments with various modifications suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected,” or “coupled” to another element, the element can be directly on, connected, or coupled to the other element and/or intervening elements may be present, including indirect and/or direct variants. In contrast, when an element is referred to as being “directly connected” or “directly coupled” to another element, there are no intervening elements present.

The terminology used herein is for describing particular embodiments only and is not necessarily limiting of the disclosure. As used herein, the singular forms “a,” “an,” and “the” include the plural forms as well, unless the context clearly indicates otherwise. The terms “comprises,” “includes,” and/or “comprising,” “including” specify the presence of stated features, integers, steps, operations, elements, and/or components but do not preclude the presence or addition of one or more other features, integers, steps, operations, elements, components, and/or groups thereof.

Aspects of the present technology are described above with reference to flowchart illustrations and/or block diagrams of methods, apparatus (systems), and computer program products according to embodiments of the present technology. It will be understood that each block of the flowchart illustrations and/or block diagrams, and combinations of blocks, can be implemented by computer program instructions. These computer program instructions may be provided to a processor of a general-purpose computer, special-purpose computer, or other programmable data processing apparatus to produce a machine that executes the instructions to create means for implementing the functions acts specified in the flowchart and/or block diagram blocks. Some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in other embodiments, the “means for” is expressed in terms of a

In this description, for purposes of explanation and not limitation, specific details are set forth, such as particular embodiments, procedures, and techniques, to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or similar phrases) at various places throughout this specification are not necessarily all referring to the same embodiment. Furthermore, the particular features, structures, or characteristics may be combined in any suitable manner in one or more embodiments. Depending on the context of discussion, a singular term may include its plural forms, and a plural term may include its singular form. Similarly, a hyphenated term (e.g., “on-demand”) may be interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

What is claimed is:

1. A data security system for safeguarding private data across databases and file-sharing platforms, the system comprising:
at least one data access proxy communicatively coupled to at least one private database and at least one file-sharing service;
at least one server communicatively coupled to the at least one data access proxy, the at least one server configured to:
determine a user identity and a request from a user to access at least one data item stored within the at least one private database or shared via the at least one file-sharing service;
validate the user and the request by inspecting the user identity, evaluating user activity history of the user, and determining permissions and restrictions associated with the user and the at least one data item;
retrieve the at least one data item from the at least one private database or the at least one file-sharing service;
inspect one or more security attributes of the at least one data item, including data origin and intended confidentiality level; and
transform the at least one data item based on one or more privacy rules, wherein transformation includes at least one of redacting sensitive information, substituting information with proxy data, or adding encryption to the at least one data item, and wherein a transformed data item is provided to the user without granting direct access to the at least one private database or the at least one file-sharing service.

2. The data security system of claim 1, wherein the at least one file-sharing service includes at least one of a Network File System (NFS), a Server Message Block (SMB) system, and/or a third-party file sharing service.

3. The data security system of claim 1, wherein the at least one server is further configured to normalize the request into a standard dialect of Structured Query Language (SQL) before retrieving the at least one data item.

4. The data security system of claim 1, wherein the one or more security attributes further include data sharing permissions, and wherein the at least one server is configured to enforce the data sharing permissions based on a role of the user.

5. The data security system of claim 1, wherein the transformation of the at least one data item further includes adding synthetic data configured to track the user activity history with the transformed data item.

6. The data security system of claim 1, wherein the at least one server is further configured to establish a secure tunnel over an encrypted authenticated connection between the at least one data access proxy and the user.

7. A data security system for protecting private data against ransomware attacks across databases and file-sharing platforms, the system comprising:
at least one security proxy communicatively coupled to at least one private database and at least one file-sharing service;
at least one server communicatively coupled to the at least one security proxy, the at least one server configured to:
receive a request from a user to access or share at least one data item stored in the at least one private database or transmitted via the at least one file-sharing service;
validate the request by evaluating a user identity, activity history, and permissions associated with the at least one data item;
monitor the at least one data item in real-time to detect unauthorized changes indicative of a ransomware attack, including sudden alterations in data format or encryption status;
transform the at least one data item based on security policies, wherein the transformation includes at least one of redacting sensitive information, providing synthetic data, or implementing write protection to prevent unauthorized encryption; and
transmit a transformed data item to the user while maintaining secure storage and exchange of the at least one data item within the at least one private database or the at least one file-sharing service.

8. The data security system of claim 7, wherein the at least one server is further configured to block a file overwrite action by the user when the unauthorized changes are detected in the at least one data item.

9. The data security system of claim 7, wherein the at least one server uses artificial intelligence and machine learning (AI/ML) methodologies to detect the sudden alterations in data format or encryption status indicative of a ransomware attack.

10. The data security system of claim 7, wherein the transformation of the at least one data item further includes obfuscating sensitive information within the at least one data item based on security policies.

11. The data security system of claim 7, wherein the at least one server is configured to manage encryption keys for the at least one data item when the at least one data item is stored in an encrypted form in the at least one private database.

12. The data security system of claim 7, wherein the at least one server is further configured to provide encryption-at-rest services for the at least one data item stored in the at least one file-sharing service.

13. A method for managing access to private data across networked environments, the method comprising:
receiving, via at least one data access proxy communicatively coupled to at least one private database and at least one file-sharing service, a request from a user to access at least one data item stored in the at least one private database or shared via the at least one file-sharing service;
analyzing, using at least one named-entity recognition model of an artificial intelligence resource communicatively coupled to at least one server, the request to identify sensitive information within the request;
validating the user by inspecting a user identity and activity history using the artificial intelligence resource to detect suspicious behavior;
retrieving the at least one data item from the at least one private database or the at least one file-sharing service via the at least one data access proxy;
transforming, using at least one large language model of the artificial intelligence resource, the at least one data item based on predefined privacy and security rules to create a transformed data item, wherein the transforming includes generating synthetic data or redacting personally identifiable information; and
providing the transformed data item to the user through a secure connection, wherein the user is prevented from directly accessing the at least one private database or the at least one file-sharing service.

14. The method of claim 13, further comprising detecting, using the at least one named-entity recognition model trained to identify personally identifiable information (PII), names, titles, and organizations within the request.

15. The method of claim 13, wherein transforming the at least one data item further comprises generating the synthetic data using the at least one large language model, wherein the at least one large language model is trained on a corpus of organizational legacy resources including files, emails, and documents.

16. The method of claim 13, wherein validating the user further comprises detecting suspicious behavior using the artificial intelligence resource, wherein the suspicious behavior includes a sudden increase in frequency of requests for the at least one data item from the user.

17. The method of claim 13, further comprising generating, via at least one server, a risk score for the user based on the activity history and the suspicious behavior detected by the artificial intelligence resource.

18. The method of claim 13, wherein providing the transformed data item further comprises establishing the secure connection using Transport Layer Security (TLS) encryption between the at least one data access proxy and the user.

19. The method of claim 13, further comprising:
combining, via the at least one server, data from a plurality of private databases into a virtual database; and
deriving the transformed data item from the virtual database.

20. The method of claim 13, further comprising:
implementing, via the at least one server, a kill switch mechanism to disable the at least one data access proxy in response to a detected breach; and
allowing an authorized administrator to override the disablement of the at least one data access proxy.
